(19) United States
(12) Patent Application Publication
(10) Pub. No.: US 2024/0200371 A1
(43) Pub. Date: Jun. 20, 2024

(54) ANGULAR ROTATION LOCKING MECHANISM

(71) Applicant: VIETTEL GROUP, Ha Noi City (VN)

(72) Inventors: DUY TUNG NGUYEN, Ha Noi City (VN); QUOC TOAN TRAN, Than Uyen District (VN); KIM BAO LE, Song Lo District (VN); PHAM TUAN NGUYEN, Ha Noi City (VN); VAN DINH PHAM, Ha Noi City (VN)

(73) Assignee: VIETTEL GROUP, Ha Noi City (VN)

(21) Appl. No.: 18/240,768

(22) Filed: Aug. 31, 2023

(30) Foreign Application Priority Data
Dec. 15, 2022 (VN) 1-2022-08226

(51) Int. Cl. E05B 83/02; B62D 33/037; E05B 83/16

(52) U.S. Cl. CPC E05B 83/02; B62D 33/037; E05B 83/16

(57) ABSTRACT

The ANGULAR ROTATION LOCKING MECHANISM (ARLM) is used on cargo transport vehicles such as trucks and ships. The structure has a large load capacity, the ability to open and close easily, flexibly, but ensures the ability to lock the brake during the transport of the vehicle, in all weather conditions. Because of a purely mechanical structure, the maintenance and repair process is simple. The main point of the design is the self-positioning between the front pedestal shaft and the locking blade during operation.

### SCOPE OF THE INVENTION

This Angular Rotation Locking Mechanism (ARLM) has a purely mechanical structure, a wide load capacity, high reliability, is easy to use, and can be applied on cars, ships and other means of transport.

### GENERAL DESCRIPTION

In recent years, the roads have developed widely, leading to the growing in popularity of the means of transport, especially trucks, trailers, and ships. Accordingly, transport vehicles often require vehicle's fold down side and tailgate to have the ability to be acted quickly, withstand large loads, and have the ability to be worked stably.

Currently, there are many methods of locking vehicle's fold down side and tailgate. However, each type has certain advantages and disadvantages. Specifically as follows:

For structures that lock and unlock using a spring-brake mechanism, which has a hook structure and is clamped by a spring. The structure is simple, but because the mechanism uses springs, its life is usually not high, the clamping ability depends heavily on the spring, the adjustment interval is short.

As for the pull and rotate structures, the mechanism is using a shaft to lock into the moving part housing. The pull and rotate structures is often heavy and difficult to operate.

To overcome the disadvantages of the above mechanisms, the authors provide the invention of ARLM. The use of ARLM can increase the ability to adjust, to working with high loads, and to open and close easily.

### SUMMARY OF THE INVENTION

The purpose of the invention is to provide the ANGULAR ROTATION LOCKING MECHANISM (ARLM), which has high vibration resistance, has the ability to be adjusted, can be worked under various environmental conditions, and can be easily manipulated.

To achieve the purpose, the ARLM has following components: a lever (1), a front locking base (2), a front pedestal fixing plate (3), a lever plain bearing (4), a front pedestal shaft (5), a position pin (6), a locking blade (7), a rear pedestal fixing plate (8), a locking nut (9), an adjusting shaft (10), an adjusting shaft bearing (11), the first screw (12), a ball screw (13), the second screw (14), the third screw (15), a wing gasket (16), the fourth screw (17), the fifth screw (18), and the sixth screw (19). An ARLM consists of two main locking platforms:

The first locking platform: the front locking base (2) is fitted to the front pedestal fixing plate (5) by the sixth screw (19) forming the first main lock assembly and fixed on the wall by the second screw (14); the front locking base (2) has a center cylinder hole for mounting to the front pedestal shaft (5); on the front locking pedestal (2) there are two holes for fastening with the position pin (6) for locking and unlocking; the lower and horizontal positions of the front pedestal shaft (5) have ball screws (13) for positioning; the fixed plate of the front locking base (2) has a semi-box shape; in the middle there is cylinder hole mounting the lever bearing and the front pedestal shaft (5).

The second locking pedestal: the locking blade (7) is fixed to the rear pedestal fixing plate by means of the third screw (15), the rear pedestal fixing plate (8) is fixed to the second wall forming a second main locking assembly, fixed by the wing gasket (16), the locking blade (7) is movable by means of applied the locking nut (9), the adjusting shaft (10) is adjusted, the adjusting shaft bearing (11) is fitted with the cylinder hole on the rear pedestal fixing plate, the fifth screw (18) fixes the adjusting shaft bearing (11), under the locking blade (7) there is a cylinder groove.

### BRIEF DESCRIPTION OF THE DRAWINGS

FIG. 1 shows the vertical view of the ARLM;

FIG. 2 shows a flat view of the ARLM;

FIG. 3 illustrates the side view of the ARLM;

FIG. 4 illustrates the measurement axis projection of the ARLM;

FIG. 5 is section A-A through the flat view of the ARLM;

FIG. 6 is cross section B-B through the vertical view of the ARLM;

### DETAILED DESCRIPTION

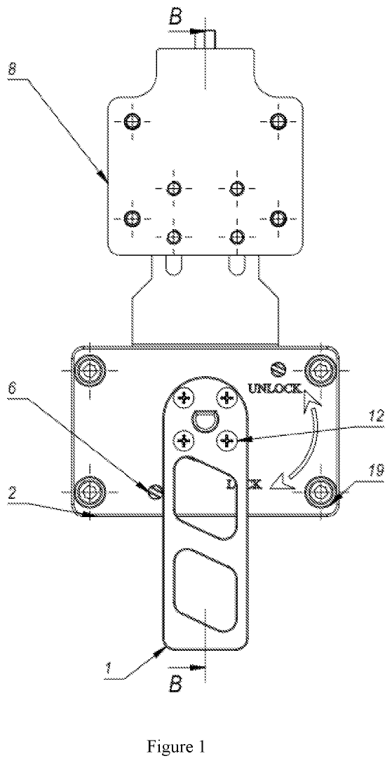

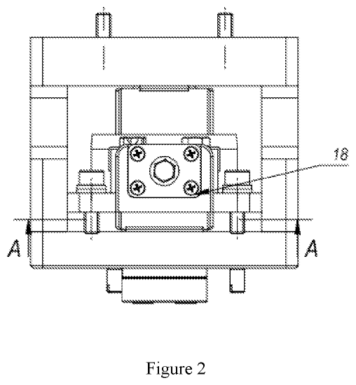

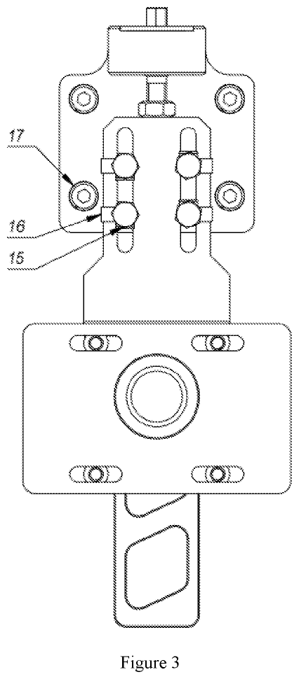

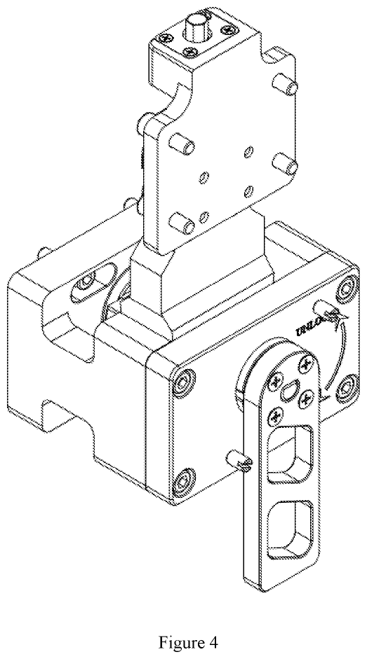

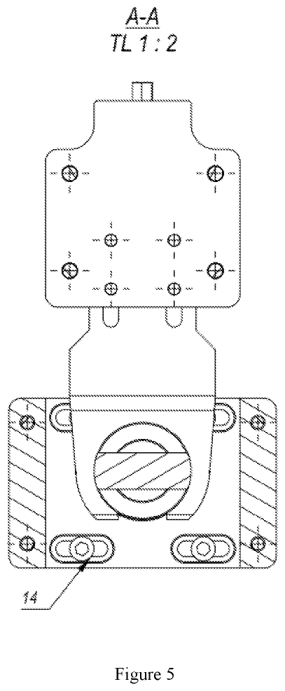

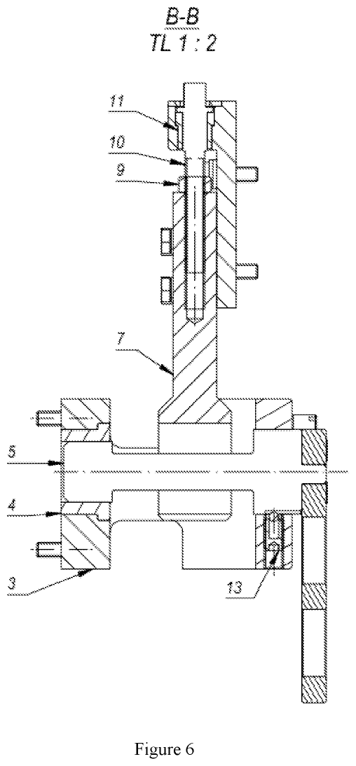

The purpose of the invention is to provide the ARLM for fold down side, tailgate of cars or ships. The mechanism has a large load capacity, the ability to open and close easily, but ensures the ability to lock and brake during the transport of the vehicle. Referring to FIGS. 1 to 6, the basic construction of this invention consists of the following parts and are assembled as follows:

The first feature of the invention: an ARLM consisting of: lever (1), front locking base (2), front pedestal fixing plate (3), lever bearing (4), front pedestal shaft (5), position pin (6), locking blade (7), rear pedestal fixing plate (8), locking nut (9), adjusting shaft (10), adjusting shaft plain bearing (11), the first screw (12), ball screw (13), the second screw (14), the third screw (15), wing gasket (16), the fourth screw (17), and the fifth screw (18).

With the lever (1) fastened to the front pedestal shaft (5) by the first screws (12), the front pedestal shaft (5) is made of alloy steel with a double-ended shaft structure, the center of the shaft is beveled on both sides to create a constriction in the center of the shaft; the front locking base (2) is fitted to the front pedestal fixing plate (5) by the fifth screw (18) forming the first main lock assembly and fixed on a plate by the second screw (14); the front locking base (2) has a center cylinder hole for mounting to the front pedestal shaft (5); on the front locking pedestal (2) there are two holes for fastening with the position pin (6) for locking and unlocking; the lower and horizontal positions of the front pedestal shaft (5) has ball screws (13) for positioning; the fixed plate of the front locking base (2) has a semi-box shape; in the middle, there is cylinder hole mounting the lever plain bearing (4) and the front pedestal shaft (5); the locking blade (7) is fixed to the rear pedestal fixing plate (8) by the third screw (15), the rear pedestal fixing plate (8) is fixed to the second plate forming the second main locking assembly, fixed by the wing gasket (16), the locking blade (7) is movable by means of applied the locking nut (9), the adjusting shaft (10) is adjusted, the adjusting shaft plain bearing (11) is fitted with the cylinder hole on the rear pedestal fixing plate (8), the fifth screw (18) fixes the adjusting shaft plain bearing (11), under the locking blade (7) there is a cylinder groove;

The second feature of the invention is the locking for plates, which moving perpendicular. The locking can be quickly operated, has the ability to remember the locking position, and the stability to be resistant to shaking and bumping.

The third feature of the invention is the main working principle: the first lock assembly is fixed on the first door plate, when the lever (1) is in the locked state, the ball screw (13) will contact in the groove on the front pedestal shaft (5), the front pedestal shaft (5) is in the horizontal state with the largest cross-section, then the locking blade (7) will attach to the front pedestal shaft (5) to create a locking state between the two main locking assemblies. In the unlocked state, the lever (1) will be pushed up in the unlocked state, the position pin (6) will limit the stroke of the lever, at this time the front pedestal shaft (5) rotates at an angle of 90 degrees and in the position with the smallest cross-section, then the second main locking assembly is fixed on the second door plate, the second door plate will be able to rotate and not in the locked state, to keep the position of the lever (1), the ball screw (13) is locked on the groove of the front pedestal shaft (5).

### BENEFITS ACHIEVED BY THE INVENTION

The ARLM is used for fold down side and tailgate on vehicles such as cars, ships, and other cargo vehicles.

The ARLM has a large load capacity, the ability to open and close easily, flexibly, but ensures the ability to lock the brake during the transport of the vehicle, in all weather conditions.

1. An angular rotation locking mechanism (ARLM), including: a lever, a front locking base, a front pedestal fixing plate, a lever plain bearing, a front pedestal shaft, a position pin, a locking blade, a rear pedestal fixing plate, a locking nut, an adjusting shaft, an adjusting shaft plain bearing, a first screw, a ball screw, a second screw, a third screw, a wing gasket, a fourth screw, a fifth screw, and a sixth screw; the lever attached to the front pedestal shaft by the first screws, the front pedestal shaft is made of alloy steel with a double-ended shaft structure, the center of the shaft is beveled on both sides to create a constriction in a center of the shaft; the front locking base is fitted to the front pedestal fixing plate by the sixth screw forming the first main locking assembly and fixed on the fixed part of the object, on which the ARLM is applied, by the second screw; the front locking base has a center cylinder hole for mounting to the front pedestal shaft; on the front locking pedestal, there are two holes for fastening with the position pin for locking and unlocking; the lower and horizontal positions of the front pedestal shaft have ball screws for positioning; a fixed plate of the front locking base has a semi-box shape; in the middle there is cylinder hole mounting the lever bearing and the front pedestal shaft; the locking blade is fixed to the rear pedestal fixing plate by means of the third screw, the rear pedestal fixing plate is fixed to the moving part of the object forming the second main locking assembly, fixed by the wing gasket, the locking blade is movable by means of the locking nut, the adjusting shaft is adjusted, the adjusting shaft bearing is fitted with the cylinder hole on the rear pedestal fixing plate, the fifth screw fixes the adjusting shaft bearing, under the locking blade there is a cylinder groove.

2. The angular rotation locking mechanism (ARLM) according to claim 1, comprising locking for plates, which moving perpendicular, locking can be quickly manipulated, has the ability to remember the locking position, and the stability to be resistant to shaking and bumping.

3. The method of using the angular rotation locking mechanism (ARLM) according to claim 1, comprising: the first lock assembly is fixed on the first door plate, when the lever is in the locked state, the ball screw will position in the groove on the front pedestal shaft, the front pedestal shaft is in the horizontal state with the largest cross-section, then the locking blade will attach to the front pedestal shaft to create a locking state between the two main lock assemblies, in the unlocked state, the lever will be pushed up in the unlocked state, the position pin will limit the stroke of the lever, at this time the front pedestal shaft rotates at an angle of 90 degrees and in the position with the smallest cross-section, then the second main lock assembly is fixed on the second door plate, the second door plate will be able to rotate and not in the locked state, to keep the position of the lever, the ball screw is locked on the groove of the front pedestal shaft.
